(19) United States
(12) Patent Application Publication
(10) Pub. No.: US 2016/0148233 A1
(43) Pub. Date: May 26, 2016

(54) Dynamic Discount Optimization Model

(71) Applicant: Staples, Inc., Framingham, MA (US)

(72) Inventors: Tchavdar Dangaltchev, Bellevue, WA (US); Courosh Mehanian, Redmond, WA (US); Karthik Kumara, Santa Clara, CA (US); Timothy Wee, San Mateo, CA (US)

(21) Appl. No.: 14/549,547

(22) Filed: Nov. 21, 2014

(51) Int. Cl. G06Q 30/02

(52) U.S. Cl. CPC G06Q 30/0206; G06Q 30/0207

(57) ABSTRACT

Technology for determining an optimal discounted price for a customer for a particular product is described. In an example embodiment, a method comprises determining a number of visits to a product page of a particular product by customers, calculating a purchase probability of a customer to purchase the particular product associated with the product page as a function of a price discount, determining a discount-corrected margin specific to the customer for the particular product based on the purchase probability of the customer, and calculating a predicted profit or a predicted revenue for the particular product resulting from the number of visits to the product page and based on the purchase probability and the discount-corrected margin of the particular product.

### BACKGROUND

The present specification generally relates to the field of optimizing discounts for sales of products. More specifically, the present specification uses linear or in some cases non-linear dynamic discount optimization models to determine optimized discounts.

The use of the internet to promote and sell products has proliferated in recent years to the point where it has become a significant portion of retail sales. While retailers commonly offer discounts to customers, the discounts are often not intelligently determined based on the specific characteristic of the user.

For instance, existing solutions generally do not intelligently customize discounts for particular users and particular products in such a way that optimizes predicted profits and revenues based on the shopping preferences of particular users when shopping for particular products.

### SUMMARY

According to one innovative aspect of the subject matter described in this disclosure, a system includes one or more processors and one or more memories storing instructions that, when executed by the one or more processors, cause the computing system to perform acts including determining a number of visits to a product page of a particular product by one or more customers, the product page being accessible by one or more client devices of the one or more customers; calculating a purchase probability of a customer to purchase the particular product associated with the product page as a function of a price discount; determining a discount-corrected margin specific to the customer for the particular product based on the purchase probability of the customer; and calculating a predicted profit or a predicted revenue for the particular product resulting from the number of visits to the product page and based on the purchase probability and the discount-corrected margin of the particular product.

In general, another innovative aspect of the subject matter described in this disclosure may be embodied in a method that includes determining, using one or more computing devices, a number of visits to a product page of a particular product by customers, the product page being accessible by a client device of the customers; calculating, using the one or more computing devices, a purchase probability of a customer to purchase the particular product associated with the product page as a function of a price discount; determining, using the one or more computing devices, a discount-corrected margin specific to the customer for the particular product based on the purchase probability of the customer; calculating, using the one or more computing devices, a predicted profit or a predicted revenue for the particular product resulting from the number of visits to the product page and based on the purchase probability and the discount-corrected margin of the particular product; tracking, using the one or more computing devices, an effect of the price discount; adapting, using the one or more computing devices, one or more algorithms for discounting price for the particular product based on the effect of the price discount, responsive to a future request for the product page by a client device of a future customer; receiving, using the one or more computing devices, a report request from a client device of a stakeholder; generating, using the one or more computing devices, a report summarizing the effect of the price discount on conversion rates; providing, using the one or more computing devices, the report for presentation on the client device of the stakeholder for display to the stakeholder; determining a discount response; determining, using the one or more computing devices, the discount response to be linear or polynomial; if the discount response is linear, then determining a base probability to purchase the particular product with no discount, and determining the linearity between the purchase probability and a variable price discount amount; if the discount response is polynomial, then determining the polynomialarity between the purchase probability and the variable price discount amount; determining, using the one or more computing devices, a retail price (p) for the particular product, and determining, using the one or more computing devices, a margin (m) for the particular product; determining, using the one or more computing devices, a value (b) reflecting the purchase probability of the customer; determining, using the one or more computing devices, a value (c) reflecting a discount response, wherein the discount response reflects an effect of a change in the price discount on the purchase probability of the customer; determining, using the one or more computing devices, whether to maximize the price discount for a positive revenue lift; computing, using the one or more computing devices, a revenue-maximum discount (dR) using the formula d_R=p−b/c; determining, using the one or more computing devices, whether the revenue-maximum discount (d [symbol] R) is greater than a threshold; calculating, using the one or more computing devices, a discounted price using the retail price (p) and the maximum price discount (dR); determining, using the one or more computing devices, whether to maximize the price discount for a positive profit lift; computing, using the one or more computing devices, a profit-maximum discount (dP) using the formula d_P=m−b/c; determining, using the one or more computing devices, whether the profit-maximum discount (dP) is greater than a threshold; calculating, using the one or more computing devices, a discounted price using the retail price (p) and the profit-maximum price discount (dR); determining, using the one or more computing devices, whether to optimize the price discount for maximal revenue; computing, using the one or more computing devices, a revenue-optimal discount (DR) using the formula D_R=p/2−b/2c; computing, using the one or more computing devices, a discounted price using the retail price (p) and the revenue-optimal discount (DR); determining, using the one or more computing devices, whether to optimize the price discount for maximal profit; computing, using the one or more computing devices, a profit-optimal discount (DP) using the formula D_P=m/2−b/2c; computing, using the one or more computing devices, a discounted price using the retail price (p) and the profit-optimal discount (DP).

Other innovative aspects include corresponding systems, methods, apparatus, and computer program products.

In general, according to yet another innovative aspect of the subject matter described in this disclosure may be embodied in a method that includes storing, in a non-transitory computer-usable storage medium coupled to a server, profile data specific to a customer; storing, in the non-transitory computer-usable storage medium, product information specific to one or more of the product or a class of products to which the product belongs, the product information including at least a profit margin at a retail price; receiving, using the server, a request for the product page associated with the product from a client device of the customer; calculating, using the server, a purchase probability of the customer for the product as a function of a price discount based on one or more of the profile data and the product information; determining, using the server, a discount-corrected margin for the product based on the purchase probability of the customer by subtracting the price discount from the profit margin; calculating, using the server, a predicted profit or a predicted revenue for the product based on the purchase probability and the discount-corrected margin of the product; calculating, using the server, an optimal price discount for the product based on the predicted profit or the predicted revenue; generating, using the server, the product page including the optimal price specific to the customer for the product and an option to purchase the product at the optimal price; and presenting, using the server, the product page on the client device of the customer for display to the customer.

These and other implementations may each optionally include one or more of the following features and/or operations. For instance, the operations include that tracking, using the server, an effect of the price discount; and adapting, using the one or more computing devices, one or more algorithms for calculating a price discount for the product based on the effect responsive to a future request for the product page by a client device of a future customer.

The disclosure is particularly advantageous in a number of respects. For example, the technology described herein can use the probability that a user will purchase a product in combination with price discounting data to satisfy one or more business earning objectives, such as maximizing profit or revenue. The features and advantages described herein are not all-inclusive and many additional features and advantages will be apparent to one or ordinary skill in the art in view of the figures and description. Moreover it should be noted that the language used in the specification has been selected for readability and instructional purposes and not to limit the scope of the inventive subject matter.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of an example system for implementing a dynamic discount optimization model.

FIG. 2 is a block diagram illustrating an example computing system.

FIG. 3 is a block diagram illustrating an example price calculation engine.

FIG. 4 is a flowchart of an example method for determining a predicted revenue or a predicted profit of a product.

FIG. 5 is a flowchart of an example method for determining a discount response.

FIGS. 6A and 6B depict flowcharts of an example method for determining a discount-corrected margin specific to a user for a particular product.

FIGS. 7A and 7B are example graphs of expected profits as a function of price discounts.

FIG. 8 is a flowchart of an example method for optimizing a price discount for a user for a particular product and for learning from a previously computed optimized price discount.

FIG. 9 is a flowchart of an example method for reporting the effect of discount on conversion rates.

### DETAILED DESCRIPTION

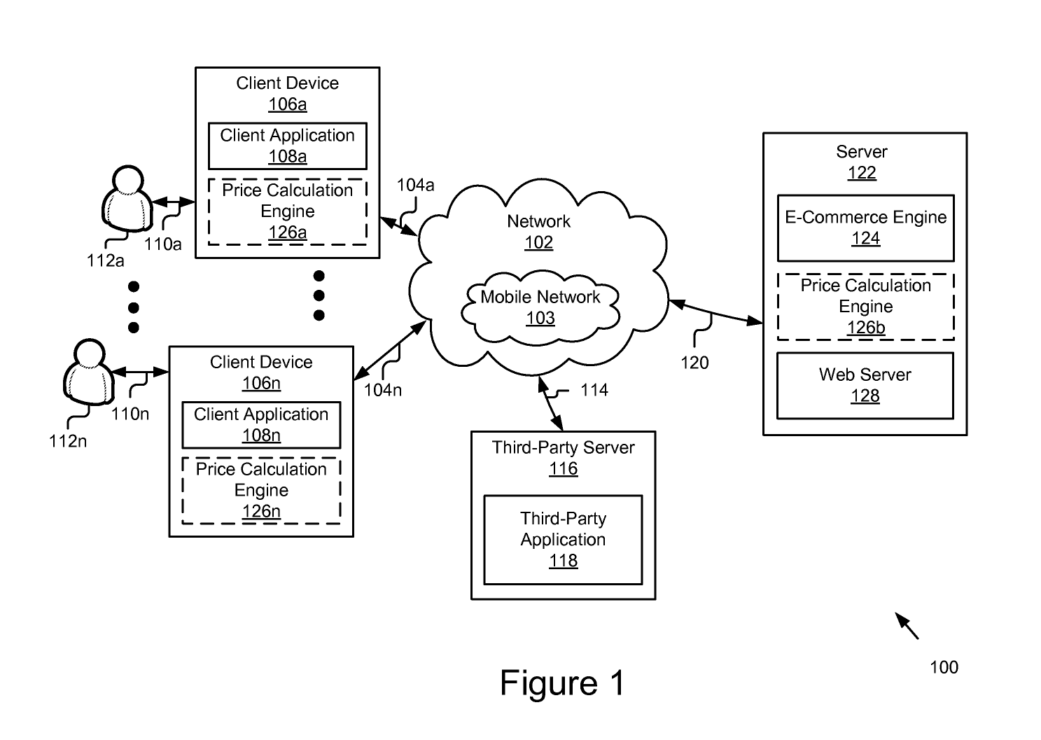

FIG. 1 is a block diagram of an example system 100 for implementing a dynamic discount optimization model. The illustrated system 100 may include a client device 106a . . . 106n (also referred to herein individually and/or collectively as 106), a third-party server 116, and a server 122, which are electronically communicatively coupled via a network 102 for interaction with one another, although other system configurations are possible including other devices, systems, and networks. For example, the system 100 could include any number of client devices 106, third-party servers 116, servers 122, and other systems and devices. The client devices 106a and 106n, and their components, may be coupled to the network 102 via signal lines 104a and 104n. The server 122 and its components may be coupled to the network 102 via signal line 120. The third-party server 116 and its components may be coupled to the network 102 via signal line 114. The users 112a and 112n may access one or more of the devices of the system 100. For example, as depicted, a user 112a may access and/or interact with the client device 106a as illustrated by line 110a and a user 112n may access and/or interact with the client device 106n as illustrated by line 110n.

The network 102 may include any number of networks and/or network types. For example, the network 102 may include, but is not limited to, one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. As depicted, the network 102 may also include a mobile network 103. The mobile network 103 may include a mobile (cellular) network for wireless communication via, for example, GSM, LTE, HSDPA, WiMAX®, etc.

The client device 106 includes one or more computing devices having data processing and communication capabilities. In some implementations, a client device 106 may include a processor (e.g., virtual, physical, etc.), a memory, a power source, a communication unit, and/or other software and/or hardware components, such as a display, graphics processor, wireless transceivers, keyboard, camera, sensors, firmware, operating systems, drivers, various physical connection interfaces (e.g., USB, HDMI, etc.). The client device 106 may couple to and communicate with other client devices 106 and the other entities of the system 100 via the network 102 using a wireless and/or wired connection.

A plurality of client devices 106a . . . 106n are depicted in FIG. 1 to indicate that the server 122 and its components may aggregate information about and provide optimized price discounts to a multiplicity of users 112a . . . 112n on a multiplicity of client devices 106a . . . 106n. In some implementations, a single user may use more than one client device 106, which the server 122 may track and provide the user a customized shopping experience to each user on each device. For example, the server 122 may track the behavior of a user across multiple client devices to more accurately determine the purchase probability of the user. In another implementation, the server 122 may track the behavior of multiple users (e.g., a class of users) using different client devices 106 and combine their attributes (e.g., behavior) to more accurately predict purchase probabilities for users with particular attributes (e.g., who belong to a certain class of users, who use certain types of user devices 106 or applications, etc.). Users may have different habits based on the device they are one, the server 122 can determine those habits and produce a more optimized experience to the user. For example, the server 122 may determine that a class of users using a certain type of client device (e.g., a desktop computer at a business) are on average approximately 40% likely to buy an item (e.g., a laser printer) that is the subject of the first product page they view.

Examples of client devices 106 may include, but are not limited to, mobile phones, tablets, laptops, desktops, netbooks, server appliances, servers, virtual machines, TVs, set-top boxes, media streaming devices, portable media players, navigation devices, personal digital assistants, etc. While two client devices 106a and 106n are depicted in FIG. 1, the system 100 may include any number of client devices 106. In addition, the client devices 106 may be the same or different types of computing devices. The client devices 106 include the capability of communicating with the server 122 via the network 102.

One or more of client devices 106 and the server 122 may include an instance of the price calculation engine 126 (the instances of the price calculation engine 126a . . . 122n may be referred to herein independently and/or collectively as 122). For example, the client device 106a and/or the server 122 may each include an instance of the price calculation engine 126 or the computing resources of the price calculation engine 126 may be distributed over the network 102 on disparate devices in disparate locations or may reside on the same locations. The client devices 106 may also store and/or operate other software such as a client application 108 (the instances of the client application 108a . . . 108n may be referred to herein independently and/or collectively as 108), an internet browser, operating system, other applications, etc., that are configured to interact with the server 122 via the network 102.

The server 122 may include one or more computing devices having data processing, storing, and communication capabilities. For example, the server 122 may include one or more hardware servers, server arrays, storage devices and/or systems, etc. In some implementations, the server 122 may include one or more virtual servers, which operate in a host server environment and access the physical hardware of the host server including, for example, a processor, memory, storage, network interfaces, etc., via an abstraction layer (e.g., a virtual machine manager).

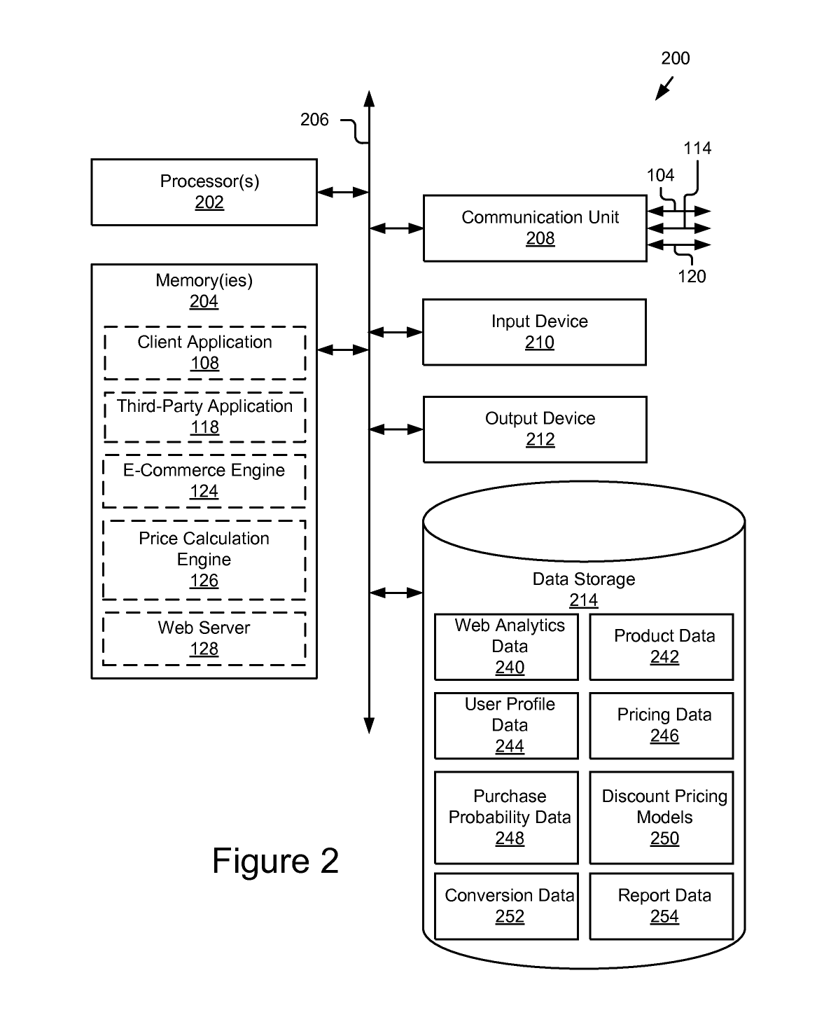

In the depicted implementation, the server 122 may include an e-commerce engine 124, the price calculation engine 126, and a web server 128. The e-commerce engine 124 is operable to provide an e-commerce service/marketplace for various products and may store and provide access to product information in a data store, such as the data storage 214 (see FIG. 2). The price calculation engine 126 is operable to implement a dynamic discount optimization model. The web server 128 is operable to receive and respond to content requests from the client devices 106 via the network 102.

The third-party server 116 may include one or more computing devices having data processing, storing, and communication capabilities. For example, the third-party server 116 may include one or more hardware servers, server arrays, storage devices and/or systems, etc. In some implementations, the third-party server 116 may include one or more virtual servers, which operate in a host server environment and access the physical hardware of the host server including, for example, a processor, memory, storage, network interfaces, etc., via an abstraction layer (e.g., a virtual machine manager). In some implementations, the third-party server 116 may include a web server (not shown) for processing content requests, such as an HTTP server, a REST (representational state transfer) service, or other server type, having structure and/or functionality for satisfying content requests and receiving content from one or more computing devices that are coupled to the network 102 (e.g., the client device 106, etc.).

In the depicted implementation, the third-party server 116 hosts services such as a third-party application 118, which may be individual and/or incorporated into the services provided by the server 122. In some implementations, the third-party application 118 provides additional acts and/or information such as browsing history, tracking information, profile data, shopping data, etc. as further described in reference to FIG. 2. In further implementations, data provided by the third-party application 118 may alternatively and/or additionally be stored in and retrieved from data sources associated with the server 122, such as the data storage 214 (see FIG. 2).

It should be understood that the system 100 illustrated in FIG. 1 is representative of an example system for implementing a dynamic discount optimization model and that a variety of different system environments and configurations are contemplated and are within the scope of the present disclosure. For instance, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Further, various entities of the system may be integrated into a single computing device or system or additional computing devices or systems, etc.

FIG. 2 is a block diagram of an example computing system 200. The example computing system 200 may represent the computer architecture of a client device 106, a third-party server 116, and/or a server 122, depending on the implementation. As depicted, the computing system 200 may include a processor(s) 202, a memory(ies) 204, a communication unit 208, an output device 212, an input device 210, and a data storage 214, which may be communicatively coupled by a communication bus 206. The computing system 200 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 200 may include various operating systems, sensors, additional processors, and other physical configurations.

The processor(s) 202 may execute software instructions by performing various input, logical, and/or mathematical operations. The processor(s) 202 may have various computing architectures to process data signals including, for example, a complex instruction set computer (CISC) architecture, a reduced instruction set computer (RISC) architecture, and/or an architecture implementing a combination of instruction sets. The processor(s) 202 may be physical and/or virtual, and may include a single core or plurality of processing units and/or cores. In some implementations, the processor(s) 202 may be capable of generating and providing electronic display signals to a display device, supporting the display of images, capturing and transmitting images, performing complex tasks including various types of feature extraction and sampling, etc. In some implementations, the processor(s) 202 may be coupled to the memory(ies) 204 via the bus 206 to access data and instructions therefrom and store data therein. The bus 206 may couple the processor 202 to the other components of the server 122 including, for example, the memory(ies) 204, the communication unit 208, the input device 210, the output device 212, and the data storage 214.

The memory(ies) 204 may store and provide access to data to the other components of the computing system 200. The memory(ies) 204 may be included in a single computing device or a plurality of computing devices. In some implementations, the memory(ies) 204 may store instructions and/or data that may be executed by the processor(s) 202. For example, as depicted in FIG. 2, the memory(ies) 204 may store one or more of the client application 108, the third-party application 118, the e-commerce engine 124, the price calculation engine 126, the web server 128, and their respective components, depending on the configuration. The memory(ies) 204 is also capable of storing other instructions and data, including, for example, an operating system, hardware drivers, other software applications, databases, etc. The memory(ies) 204 may be coupled to the bus 206 for communication with the processor(s) 202 and the other components of computing system 200.

The memory(ies) 204 include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor(s) 202. In some implementations, the memory(ies) 204 may include one or more of volatile memory and non-volatile memory. For example, the memory(ies) 204 may include, but is not limited to, one or more of a dynamic random access memory (DRAM) device, a static random access memory (SRAM) device, a discrete memory device (e.g., a PROM, FPROM, ROM), a hard disk drive, an optical disk drive (CD, DVD, Blue-ray™, etc.). It should be understood that the memory(ies) 204 may be a single device or may include multiple types of devices and configurations.

The bus 206 can include a communication bus for transferring data between components of a computing device or between computing devices, a network bus system including the network 102 or portions thereof, a processor mesh, a combination thereof, etc. In some implementations, the price calculation engine 126, the e-commerce engine 124, the web server 128, and various other components operating on the server 122 (operating systems, device drivers, etc.) may cooperate and communicate via a communication mechanism included in or implemented in association with the bus 206. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 208 may include one or more interface devices (I/F) for wired and wireless connectivity with the network 102 and the other components of the system 100, for example, the client device 106, the third-party server 116, the server 122, etc. For instance, the communication unit 208 may include, but is not limited to, CAT-type interfaces; wireless transceivers for sending and receiving signals using Wi-Fi™; Bluetooth®, IrDA™, Z-Wave™, ZigBee®, cellular communications, etc.; USB interfaces; various combinations thereof; etc. The communication unit 208 may include radio transceivers (5G, 4G, 3G, 2G, etc.) for communication with the network 102 and/or the mobile network 103, and radio transceivers for Wi-Fi™ and close-proximity/personal area (e.g., Bluetooth®, NFC, etc.) connectivity, geo-location transceivers (e.g., GPS) for receiving and providing location information for the corresponding device, and the like. The communication unit 208 may be coupled to the other components of the computing system 200 via the bus 206. The communication unit 208 may be coupled to the network 102 as illustrated by the signal lines 104, 114, or 120, depending on the configuration. In some implementations, the communication unit 208 can link the processor 202 to the network 102, which may in turn be coupled to other processing systems. The communication unit 208 can provide other connections to the network 102 and to other entities of the system 100 using various standard communication protocols, including, for example, those discussed elsewhere herein.

The input device 210 may include any device for inputting information into the computing system 200. In some implementations, the input device 210 may include one or more peripheral devices. For example, the input device 210 may include a keyboard (e.g., a QWERTY keyboard), a pointing device (e.g., a mouse or touchpad), microphone, an image/video capture device (e.g., camera), etc. In some implementations, the input devices 214 may include a touch-screen display capable of receiving input from the one or more fingers of the user. For instance, the structure and/or functionality of one or more of the input device 210 and the output device 212 may be integrated, and a user of the computing system 200 may interact with the computing system 200 by contacting a surface of a display (e.g., an output device 212) using one or more fingers. In this example, the user could interact with an emulated (e.g., virtual or soft) keyboard displayed on a touch-screen output device 212 by using fingers to contact the display in the keyboard regions.

The output device 212 may be any device capable of outputting information from the computing system 200. The output device 212 may include one or more of a display, a printer, a 3D printer, a haptic device, audio reproduction device, etc. In some implementations, the output device is a display which may display electronic images and data output by the computing system 200 for presentation to a user 106. The output device 212 may include any conventional display device, monitor or screen, including, for example, an organic light-emitting diode (OLED) display, a liquid crystal display (LCD), etc. In some implementations, the output device 212 may include a touch-screen display capable of receiving input from one or more fingers of a user 106. For example, the output device 212 may include a capacitive touch-screen display capable of detecting and interpreting multiple points of contact with the display surface. In some implementations, the computing system 200 may include a graphics adapter (not shown) for rendering and outputting the images and data for presentation on output device 212. The graphics adapter (not shown) may be a separate processing device including a separate processor and memory (not shown) or may be integrated with the processor 202 and memory 206.

The data storage 214 is an information source for storing and providing access to data. The data stored by the data storage 214 may organized and queried using various criteria including any type of data stored by them, such as a customer identifier, IP address, rewards account number, product identifier, product name, where products were purchased from, etc. The data storage 214 may include data tables, databases, or other organized collections of data. Examples of the types of data stored by the data storage 214 may include, but are not limited to, web analytics, product data, user profiles 244, pricing data 246, purchase probability data 248, discount pricing models 250, conversion data 252, report data 254, etc., discussed elsewhere herein.

The data storage 214 may be included in the computing system 200 or in another computing system and/or storage system distinct from but coupled to or accessible by the computing system 200. The data storage 214 can include one or more non-transitory computer-readable mediums for storing the data. In some implementations, the data storage 214 may be incorporated with the memory(ies) 204 or may be distinct therefrom. In some implementations, the data storage 214 may store data associated with a database management system (DBMS) operable on the computing system 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The various types of data 240, 242, 244, 246, 248, 250, 252, and 254 stored in the data storage 214, as described elsewhere herein, may be combined, further delineated, linked, and associated, etc. They may be retrievable and/or searchable, for example, using a unique identifier, keywords, and/or other search terms. The various components of the system 100, including for example, those discussed in reference to FIGS. 1, 2, and 3, may access (e.g., store, create, retrieve, modify, read, delete, etc.) data stored therein to facilitate the operations of the components. Non-limiting examples of these types of data, as well as methods to access data, by the various components of the system 100, are disclosed herein, but it should be understood that other types of data and access methods are possible and contemplated.

Web analytics data 240 may include data that can be learned from user interactions on computing devices 106 coupled via the network 102 with the server 122, the third-party server 116, and/or any other components of the system 100. The web analytics data 240 may include past behavior data describing the past actions of a customer, such as accessing, entering, interacting with, and leaving interfaces associated with the services provided by the server 122, the third-party server 116, and/or other components of the system. For example but not limitation, the web analytics data 240 may include the clickstream path of a user, the geolocation history and/or current geolocation of a user, data segmentation by user attribute (e.g., demographics such as gender, ethnicity, age, interest, entry point, user device, user application, product preference, classification, etc.), the browsing history associated with a product or class of products visited by a user, etc., which can be used by the server 122 for dynamically determining discounts for products, as discussed elsewhere herein.

The web analytics data 240 may be aggregated from one or more information sources by the server 122. Information sources may include data storage 214, the third-party server 116, or other computing and/or storage components of the system 100. For example, the information sources may store and provide web analytics data such as web server access logs, user application usage logs, cookies, any real-time interaction data acquired by client and/or server-side modules (e.g., received from a client-side user tracking module, such as a tracking module implemented using JavaScript, a server log, etc.) in real-time or near real-time associated with the current or recent actions of a customer in association with an interface (e.g., user's identity and/or current on-site or in-app behavior, such as referrer, selections, items in cart, path, elements clicked, information typed, items hovered over, searches made, etc.). In some implementations, the web analytics data may include timestamps associated with each action taken by the users when interacting with the application interfaces, as well as user identifiers associated with the users and/or the user devices 106 of the users 112. Non-limiting examples of user identifiers include a user name, a unique ID, an IP address, a MAC address, or the like.

The web analytics data 240 may be accessible (e.g., searchable, readable, modifiable, etc.) by other components of the system 100. In some implementations, the third-party application 118, the e-commerce engine 124, the price calculation engine 126, the web server 128, etc., may access the web analytics data 240. For example, the client application 108 and/or the web server 128 may track user interactions/behavior on the client device 106 and store the user interactions as web analytics data 240. In another example, the price calculation engine 126 may analyze the attributes stored in the web analytics data 240 to determine additional attributes of a user or class of users such as their likelihood to be affected by a certain discount in price on a product for sale using the e-commerce engine 124, as described elsewhere herein.

Product data 242 may include data and attributes concerning one or more products. Non-limiting examples of products includes office supplies, electronics, furniture, consumables, clothing, and/or any other consumer or business products. The product data 242 includes a plurality of product records respectively describing products available via the e-commerce engine 124. Each product record may describe the various aspects of the products. Each record may include one or more product attributes characterizing the product. Each record may also include unique product identifiers, names, descriptions, manufacturer info, specifications, photos, videos, reviews, ratings, etc. for products.

The product data 242 may be linked with the other data such as the web analytics data 240. For example, the web analytics data 240 may include information about a particular product such as the frequency that a particular product is viewed by a user or class of users, the popularity of the product or a brand, etc. The product data 242 may be linked to the pricing data 246 to associate current and past offered prices of a product to the product or an attribute of the product. For example, the product data 246 may be linked to pricing data 246 in order to include a retail price, an average sales price, etc. as described in reference to the pricing data 246. In some implementations, the product data 242 may be retrievable modifiable by other components of the system 100. For example, the e-commerce engine 124 and/.or web server 128 may retrieve product data 242 for a particular product for display to a user on a client device 106. The price calculation engine 126 may retrieve information from the product data 242 and data linked thereto to determine the likelihood that a particular discount will affect the probability that particular user or class of users will purchase a product, as discussed elsewhere herein.

The user profile data 244 includes profiles for each of the users 106 of the system 100. A given user's profile may include the user's user account and attributes describing the user. The user account may include information associated with the user's identity on the services provided by the server 122, such as a username, password, preference data, payment information, etc. The attributes may characterize the user's preferences and/or identity. User attributes may be based on information provided by the user or information learned from user interactions with the system 100 through various computer-learning methods, as discussed elsewhere herein. Non-limiting examples of user attributes include an e-mail address, IP address, demographics data, spending potential, gender, whether a user is a consumer or a business, location data, user id, rewards account number, products of interest or potentially of interest to the user, product purchase history, devices registered to the user, age, ethnicity, marital status, etc. In a further example, the user profile data 244 may include a user classification scheme and may classify user's based on attributes. The classifications to which a given user is classified into may be stored in the user's profile data 244 as attributes describing that user.

The user profile data 244 may be correlated with other data in the data storage 214. In some implementations, the user profile data 244 may be linked to the web analytics data 240, purchase probability data 248, discount pricing models 250, conversion data 252, report data 254, etc. For example, the web analytics data 240 associated with a particular user may be linked to that user's user profile data 244. In another example, the purchase probability data 248, the pricing data 246, and the conversion data 252 associated with a particular user may be linked to that user's user profile data 244, and so forth.

Pricing data 246 may include data pertaining to the pricing of a particular product or class of products and may be linked to other data in the data storage 214 (e.g., the product data 242, the user profile data 244, etc.). In some implementations, the pricing data 246 includes a history of past offers, retail prices (e.g., MSRP), average sale prices on one or more competitive websites, profit margins, wholesale product costs, etc. The history of past offers may include prices and offers for discount prices to particular users or various classes of users. For example, the history of past offers may include average sales prices for products on a first party website. In another example, the history of past offers may include the optimized discounts previously offered to the particular users or various classes of users. The average sale prices on one or more competitive websites may include data reflecting the sales prices, discounts, and other offers for a particular product from one or more competitive retailers. For example, the pricing data 246 may include an average sales price and the standard deviation therefrom by various retailers for a particular product.

Purchase probability data 248 may include data describing the probability that users or classes of users will purchase particular products or classes of products at particular prices (e.g., retail prices, various discounted prices, etc.). The purchase probability data 248 may include historical purchase probabilities learned from past offers to sell products at discounted prices. In some implementations, the purchase probability 248 includes probability data for a particular user. This probability data may be linked to that user's user profile in the user profile data 244. A user's probability data may reflect the probability that the user will buy a particular product an initial price and, in some implementations, a discount response for that user and/or that product/transaction.

In some implementations, the purchase probability data 248 includes predicted probabilities at certain discounts corresponding to certain attribute triggers. For example, the purchase probability data 248 may include that a person who frequents webpages associated with a certain product will have a 35% probability to purchase the product at a 5% price discount. In another example, the purchase probability data 248 may include a probability that a person who has looked at several webpages for inkjet printers is 10% likely to purchase a particular printer when viewing the product page for the printer at a retail price, but 25% likely to purchase the printer when viewing the product page with a 10% discount from the retail price. Numerous other variations are also possible and contemplated.

In some implementations, the purchase probability data 248 may be linked to the web analytics data 240, the product data 242, the user profile data 244, etc. For example, the purchase probability data 248 for a particular product may be linked to that product's product data 242. Corresponding probability data 248 may be linked to the user profile data 244 for users or classes of users.

Discount pricing models 250 may pertain to the effect of model price discounts based on certain factors. In some implementations, the discount pricing models 250 may be based on series of purchase probabilities at a plurality of price discounts for a product. In some implementations, the discount pricing models 250 may be based on discount response(s). The models in the discount pricing models 250 may be determined by the probability computation module 322 or the learning module 326 based on historical trial and error, computer learning, administrator programming, etc. In some implementations, the models are formed by extrapolating multiple discreet purchase probabilities into a relationship, which may be linear, polynomial, etc., as described elsewhere herein.

In some implementations, the discount pricing models 250 may be indexed, retrievable, and/or searchable by attribute. For example, if a particular user requests a product page for a particular product, the price calculation engine 126 may recognize that the user has attribute A (as described by the user's profile data 244) and the product has attribute B (as described by the product's product data 242) and may search the discount pricing models 250 for a model corresponding to attributes A and B.

Discount pricing models 250 may be based on particular users, classes of users, particular products, and/or classes of products. The discount pricing models 250 may be accessible by other components of the system 100, such as the price calculation engine 126, which may access the discount pricing models 250 to determine purchase probabilities, as described in further detail elsewhere herein.

A discount response reflects the effect a discount has on the probability that a user will purchase a product. The discount may be a variable discount. The discount response may be determined by the price calculation engine 126 using trial and error, computer learning, pre-determined models, etc., as described elsewhere herein.

In some implementations, a linear discount response may be used. The linear discount response may reflect that the probability and discount are directly proportional to each other. For example, the discount response may describe that a user may effectively have a relatively low (e.g., 0, 1, 2, 3, etc., percent) likelihood to purchase a product at a retail price and a relatively high (e.g., 100, 99, 98, 97, etc., percent) likelihood to purchase the product at a discount of one hundred percent off the retail price (e.g., free). Thus, the discount response having a slope of one provides a reliable approximation of user purchase probability over the discount range. In other words, a change under a linear discount response, in a normalized probability may be equal to a corresponding change in a normalized discounted price. In some instances, the discount response may have a slope other than one (e.g., 2, 2.5, 3, etc.).

In some implementations, a discount response may be limited to a certain portion of the price range of a price. In other words, a discount in price may in some cases not have a substantial effect on the likelihood that a user will purchase a product until the discount reaches a certain threshold or range. For instance, the discount response by users for a given product may substantially linearly increase as the discount increases from 25%-50% off of the retail price of that product, but may not change substantially outside of that range. In another example, the discount response by users for a given product may substantially linearly increase as the discount increases from 5%-25% off of the retail price of that product, but may not change substantially outside of that range. In these implementations, after a certain threshold of price discount, additional price discounts may have a substantially effect on the probability that a user will purchase the product, and thus there is little benefit to the retailer to further discount the price. It should be understood that the above examples are provided by way of illustration and that numerous other variations are also possible.

By way of further example, but not limitation, the market price of a tablet computer may range from $200 to $250, but the retail price may be $400. In this example, it is unlikely that a discounted price of $360 will result in a substantially higher probability to purchase the tablet than the full retail price of $400. However, a discount from $250 to $200 would likely result in a substantial change in the probability that a user would purchase the tablet. The discount response may be substantially linear from an initial price near $250 to a final price near $200. The price calculation engine 124 may determine the initial and final prices, for example, using market prices for products, profile data describing the behavior of a specific user or class of users to which the user belongs, etc.

In some instances, the discount response may be non-linear (e.g., polynomial, etc.) Polynomialarity, as used herein, refers to a discount response that is non-linear or polynomial in nature. A polynomial discount response can be represented by any shape or complexity of curve. In some implementations, a polynomial discount response can be determined by trial and error and then extrapolating a curve representing the discount response from the results of the trial and error experimentation. For example, the price calculation engine 126 may make a series of offers to certain individuals having certain attributes, or belonging to a certain class, at different discount prices, thereby establishing purchase probabilities for users with certain attributes to purchase at a range of discounted prices from which a continuous curve can be calculated. Although, in some implementations the polynomial discount response is described as continuous, these implementations should not be construed as limiting and it should be understood that the discount response may be discontinuous in some further implementations. For instance, the discount response may include a series of discreet values representing purchase probabilities at particular price discounts.

Conversion data 252 may include data pertaining to the conversion of potential sales to completed sales. The conversion data 252 may reflect each step of a typical sales funnel for each product. For instance, for a given product, the conversion data 252 associated with that product may describe the number of users who viewed an interface featuring that product for sale, the number of users that added the product to a virtual shopping cart responsive to receiving a discount, the number of users that began the checkout process, the number of users that did or did not complete the checkout process, etc.

In some implementations, the conversion data 252 may include the ratio of users who purchased a product at a certain discount to those who did not purchase it at that discount. For example, the conversion data 252 includes data reflecting that 10% of users visiting a product page displaying a product at a retail price elected to purchase the product. In another example, the conversion data 252 includes data reflecting that 35% of users, in some cases having a particular common attribute (or set of attributes), visiting a product page displaying a product page with a discounted price of 10% off the retail price purchased the product.

Conversion data 252 may be linked to other types of data in the data storage 214, for example 244, 248, 250, 254, etc. The learning module 326, or another component of the system 100, may process the conversion data 252 to increase the accuracy of the purchase probabilities computed by the probability computation module 322, and ultimately optimize discount computed by the price computation module 324, as discussed elsewhere herein.

Report data 254 may include data pertaining to reports related to discounts generated by the price calculation engine 126. The report data 254 may include reports reflecting, for example, the performance of components of the system 100, the computing system 200, the price calculation engine 126, etc. as well as one or more of the types of data in the data storage 214. For example, the report data 254 may be linked to product data 242 and conversion data 252, such that a report may include the discount response, the discount corrected margin (e.g., the profit), product or brand specific data, as well as the effectiveness of discounts on conversion, although it should be understood that reports including any data or combination of data from the data store 214 may be generated and provided to stakeholders.

As depicted in FIG. 2, the computing system 200 may include a client application 108, a third-party application 118, an e-commerce engine 124, a price calculation engine 126, and a webserver 128, depending on the configuration. For instance, the client device 106 may include a client application 108 and/or the price calculation engine 126 or components thereof; the third-party server 116 may include a third-party application 118; and the server 122 may include an e-commerce engine 124, a web server 128, and/or the price calculation engine 126 or components thereof, although other configurations are also possible and contemplated.

These components 108, 118, 124, 126, and/or 128, and/or components thereof, may be communicatively coupled by the bus 206 and/or the processor(s) 202 to one another and/or the other components 202, 204, 208, 210, 212, and 214 of the computing system 200. In some implementations, the components 108, 118, 124, 126, and/or 128 may include computer logic (e.g., software logic, hardware logic, etc.) executable by the processor(s) 202 to provide their acts and/or functionality. In any of the foregoing implementations, these components 108, 118, 124, 126, and/or 128 may be adapted for cooperation and communication with the processor(s) 202 and the other components of the computing system 200.

The client application 108 includes computer logic executable by the processor(s) on a client device 106 to provide for user interaction, receive user input, present information to the user via a display, and send data to and receive data from the other entities of the system 100 via the network 102. In some implementations, the client application 108 may generate and present user interfaces based at least in part on information received from the e-commerce engine 124 and/or the web server 128 via the network 102. For example, a customer/user 190 may use the client application 108 to receive the product pages provided by the server 122, view various products available online, at products to a virtual cart, purchase products, receive discounts on products, etc. In some implementations, the client application 108 includes a web browser and/or code operable therein, a customized client-side application (e.g., a dedicated mobile app), a combination of both, etc.

The third-party application 118 includes computer logic executable by the processor(s) 202 to provide additional acts and information to the server 122. In some implementations, the third-party application 118 provides additional information about a user such as browsing history, tracking information, etc. In some implementations, the third-party application 118 provides additional information about a product, such as competitive pricing, competitive offers, web analytics, etc. For example, the third-party application 118 may track a user's interaction with one or more websites and provide that information to the server 122 (e.g., via the network 102). In another example, the third-party application 118 may provide analysis data to the server 122 for storage in the web analytics data 240 (e.g., demographic data, pricing data, behavior analysis, etc.).

The e-commerce engine 124 includes computer logic executable by the processor(s) 202 to provide an e-commerce service/marketplace for various products and may store and provide access to product information (e.g., images, descriptions, categories, specifications, reviews, ratings, retailers, etc.) in the product data 242 in a data storage 214. The e-commerce engine 124 may also place and provide for order fulfillment for the products including order delivery status and item returns. For example, a user may place orders for and/or pay for products, such as office supplies, consumer electronics, other products, etc., ordered on an e-commerce marketplace using a client device 106.

The e-commerce engine 124 may also receive, manage, analyze, store, and provide access to inventory, sales, rewards, and product data and, in some implementations, may generate analytics and reports for review by management to assess the performance and effectiveness of the server 122. The e-commerce engine 124 may communicate with the price calculation engine 126 and the web server 128 to facilitate their operations and may be coupled to the data storage 214 to store retrieve, and/or manipulate data stored therein. For example, the e-commerce engine 124 may retrieve product data from a third-party server 116 and store it in the product data 242.

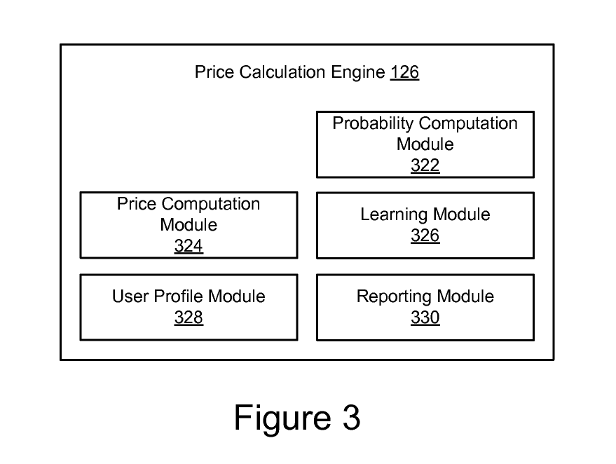

The price calculation engine 126 includes computer logic executable by the processor(s) 202 to implement dynamic discount optimization models. The price calculation engine 126 is coupled to the data storage 214 to store, retrieve, and/or manipulate data stored therein and may be coupled to the e-commerce engine 124, the web server 128 and other components of the system 100 to exchange information therewith. Additional structure, acts, and/or functionality of the price calculation engine 126 are described in greater detail with reference to at least FIGS. 3-9, for example.

The web server 128 includes computer logic executable by the processor(s) 202 to processes content requests. The web server 128 may include an HTTP server, a REST (representational state transfer) service, or other suitable server type. The web server 128 may receive content requests (e.g., HTTP requests) from client devices 106, cooperate with the e-commerce engine 124 and/or price calculation engine 126 to determine the content, retrieve and incorporate data from the data store 214, format the content, and provide the content to the client devices.

In some instances, the web server 128 may format the content using a web language, such as HTML, XML, JSON, or another suitable language, and provide the content to a corresponding client application 108 for processing and/or rendering to the user for display. The web server 128 may also provide code scripts (e.g., JavaScript) in association with the content (e.g., web page) to provide various acts and/or functionality, such as components or aspects of the price calculation engine 126.

The web server 128 may be coupled to the data storage 214 to store retrieve, and/or manipulate data stored therein and may be coupled to the e-commerce engine 124 to facilitate its operations. For example, the web server 128 may allow a user on a client device 112 to communicate with the e-commerce engine 124.

FIG. 3 is a block diagram of an example price calculation engine 126. In the depicted implementation, the price calculation engine 126 includes a probability computation module 322, a price computation module 324, a learning module 326, a user profile module 328, and a reporting module 330.

The components 322, 324, 326, 328, and/or 330 may be communicatively coupled by the bus 206 and/or the processor(s) 202 to one another and/or the other components 208, 210, 212, and 214 of the computing system 200. In some implementations, the components 322, 324, 326, 328, and/or 330 may include computer logic executable by the processor(s) 202 to provide their acts and/or functionality. In any of the foregoing implementations, these components 322, 324, 326, 328, and/or 330 may be adapted for cooperation and communication with the processor(s) 202 and other components of the computing system 200, such as the data storage 214 and/or the memory(ies) 204.

The probability computation module 322 may include computer logic executable by the processor(s) 202 to determine the probability that a user will purchase a product under certain circumstances. The probability computation module 322 may communicate with the other components of the price calculation engine 126 and/or store data in the data storage 214. In an illustrative example, the probability computation module 322 receives user profile data from the user profile module 228, uses it to determine purchase probability, and sends the purchase probability to the price computation module 224 for further processing. In another illustrative example, the probability computation module 322 retrieves web analytics data 240, user profile data 244, and product data 242 from the data storage 214, uses these data types to calculate a purchase probability, and stores the probability in the purchase probability data 248 for access by other components of the price calculation engine 126. It should be understood that other configurations are possible and contemplated. Additional structure, acts, and/or functionality of the probability computation module 322 may be described below with reference to FIGS. 3-9.

The price computation module 324 may include computer logic executable by the processor(s) 202 to determine a predicted profit or revenue (also referred to herein sometimes as simply profit or revenue, respectively) using purchase probability data 248. The price computation module 324 may be coupled for communication with the other modules of the price calculation engine 126 and coupled to the data storage 214 to store, update, and retrieve data. For example, the price computation module 224 may retrieve purchase probability data 248, discount pricing models 250, and/or product data 242, and use them to calculate discounts, such as optimized price discounts.

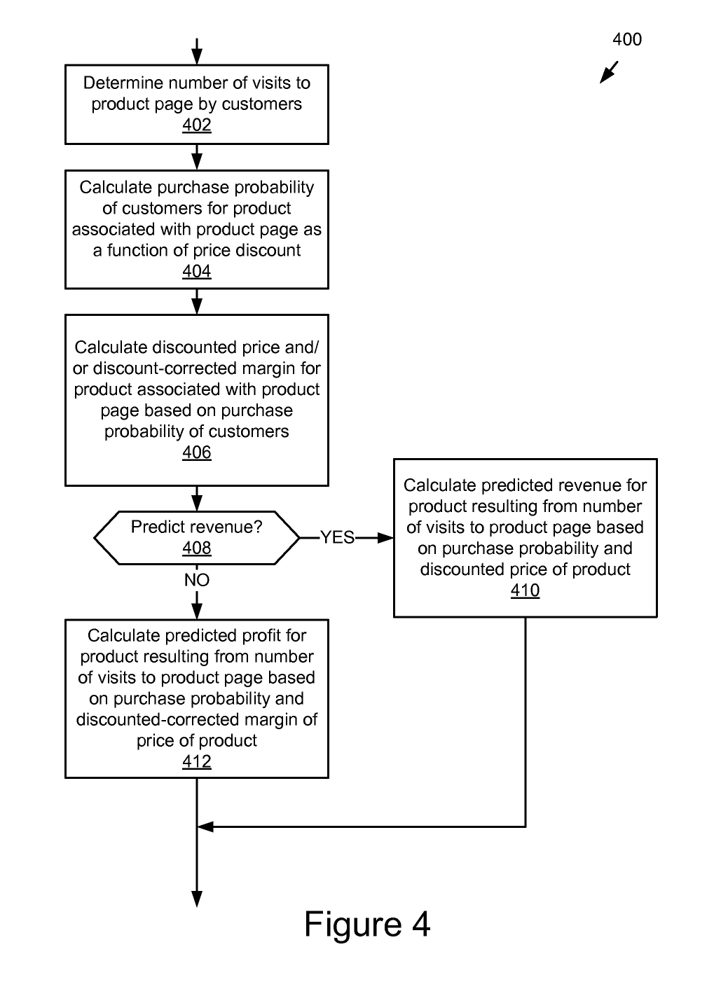

The price computation module 224 may be coupled to and provide the data processed by it (e.g., discounts, predicted profits, predicted revenues, etc.) computed by it to the e-commerce engine 124 and/or the web server 128, and or may store the data in the data storage 214 as pricing data 246. Additional structure, acts, and/or functionality of the computation module 324 may be described below with reference to FIGS. 4-9.

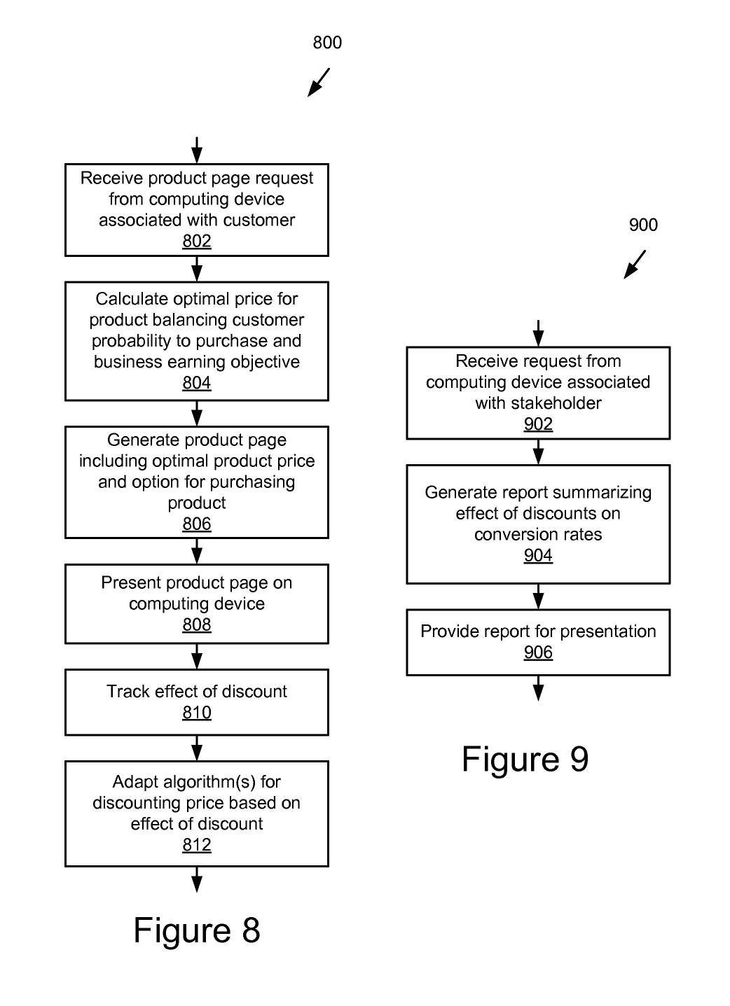

The learning module 326 may include computer logic executable by the processor(s) 202 to track the effect of offering optimized discounts and adapt the data in the data store and/or the acts and operations of the price calculation engine 126 based thereon. The learning module 326 may communicate with other components and/or may be coupled to the data storage 214 to access data therein (e.g., store, retrieve, manipulate, etc., data). In some implementations, the learning module 326 may process the pricing data 246 and/or the conversion data 252 stored by the e-commerce engine 124 in the data storage 214 to determine the effect of discounts on conversion rates, and store the learning data in the data storage 214. For example, the learning module 326 may update purchase probability data 248 associated with a product and/or user based on the conversion data 252 and/or pricing data 246 associated with that product or user. Additional structure, acts, and/or functionality of the learning module 326 may be described below with reference to FIGS. 4 and 8.

The user profile module 328 may include computer logic executable by the processor(s) 202 to manage user profiles for the users of the system 100. The user profile module 328 may track and accumulate user profile data specific to users and/or classes of users. The user profile module 328 may receive user-related information from various information sources (e.g., the e-commerce engine 124, or the web server 128, the third-part application 118, etc.) and store that information as user profile data 244 in associate with the users to which the data corresponds. In some implementations, the user profile module 328 may process interaction data associated with a given user to determine attributes about the user (e.g., products and or product categories the user likes, discount types that are effective for that user, etc.) and may store those attributes as user profile data 244 in the data storage 214.

In some implementations, users may manage their user profiles using interfaces presented by corresponding client applications 108. the user profile module 328 may cooperate with the web server 128 to provide user profile data (e.g., preferences, settings, attributes, user data, etc.) for a given user to the client application 108 of the user for display and/or modification. Modifications may be received by the web server 128 and relayed to the user profile module 328, which may update the user profile in the data storage 214.

The reporting module 330 may include computer logic executable by the processor(s) 202 to generate reports summarizing the effect of discounts on conversion rates. In some implementations, the reporting module 330 may be configured to receive requests from stakeholders (e.g., stakeholders may send requests to the reporting module 330 via the network 102 using a client device 106), generate reports in response to the requests, send the report to a client device via the network and/or store the report in the report data 254. The reporting module 330 may communicate with other components of the price calculation engine 126 and/or may access the data stored in the data store 214 to generate the reports. For example, the reporting module 330 may communicate with web server 128 to receive report requests, generate reports responsive to the requests, and/or provide the reports to the web server 128 for processing and/or relaying to the client device 106 of the user for display. In some implementations, the reporting module 330 may store the reports generated by it as report data 254 in the data storage 214.

Additional structure, acts, and/or functionality of the report module 330 may be described below with reference to FIG. 9.

FIG. 4 is a flowchart of an example process 400 for determining a predicted revenue or a predicted profit of a product. In block 402, the web server 128, e-commerce engine 124, or another component determines the number of visits to a product page by users. The web server 128, e-commerce engine 124, or other component may store the number of visits as web analytics data 240 or product data 242 in the data storage 214, for example.

In block 404, the probability computation module 322 may calculate purchase probability of customer(s) for a product associated with a product page as a function of price discount. In some implementations, the probability computation module 322 may retrieve one or more purchase probabilities for a particular user, a class of users to which the user belongs, etc., for a particular product at an initial price from the purchase probability 248 in the data storage 214. For example, the probability computation module 322 may determine a purchase probability for a particular user viewing a particular product page (e.g., in response to the price calculation engine 126 receiving a request via the web server 128 to determine an optimized price) by matching one or more attributes for the particular user and/or product to particular probabilities in the purchase probability data 248. The probability computation module may retrieve the matching purchase probability and provide it to the price computation module 244 and/or store it in the data storage 214 (e.g., in the product data 242, user profile data 244, etc.) or link it to another type of data in the data storage 214 (e.g., in the product data 242, user profile data 244, etc.).

In some implementations, at least some of the data stored as purchase probability data 248 and/or the discount pricing models 250 may be entered by an administrator. In some implementations, the learning module 326 may track user behavior (e.g., as described by the web analytics data 240) in association with the products (e.g., whether users purchase the products as described by the conversion data 252) to determine purchase probabilities for specific users, classes of users, products, classes of products, etc., and store the learned purchase probabilities as purchase probability data 248 in the data storage 214 in association with the users and/or products to which they correspond.

The probability computation module 324 may calculate a purchase probability for a product page view where the product is offered at a discounted price. The probability computation module 324 may be aware of an initial purchase probability of a user at an initial price (e.g., a retail price) due to a calculation or data retrieval of pricing data 246 from the data storage 214 as described elsewhere herein. In some implementations, the probability computation module 324 may calculate the purchase probability at one or more discounted prices based on the initial purchase probability and a discount response and/or discount pricing model. For example, the probability computation module 324 may use the initial purchase probability to anchor the discount response and then determine a variable purchase probability at one or more discreet discounted prices and/or at a continuous range of discounted prices. In another example, the probability computation module 324 may calculate one or more purchase probabilities at one or more discounted prices using an appropriate discount pricing model. The probability computation module 324 may match attributes of a user (e.g., clickstream history, purchase history, etc.) and a product (e.g., average sales price, deviation in sales prices from the average sales price, etc.) with a model in the discount pricing models 250. It may then use the model to determine purchase probabilities at a variable discounted price.

In some implementations, the probability computation module 324 may retrieve a predetermined purchase probability for a discounted price from the purchase probability data 248. For example, the purchase probability data 248 may contain a purchase probability for the user, similar users, similar products, etc., for discounted prices, which may be accessed by the probability computation module 324 to determine a particular purchase probability at a particular price discount.

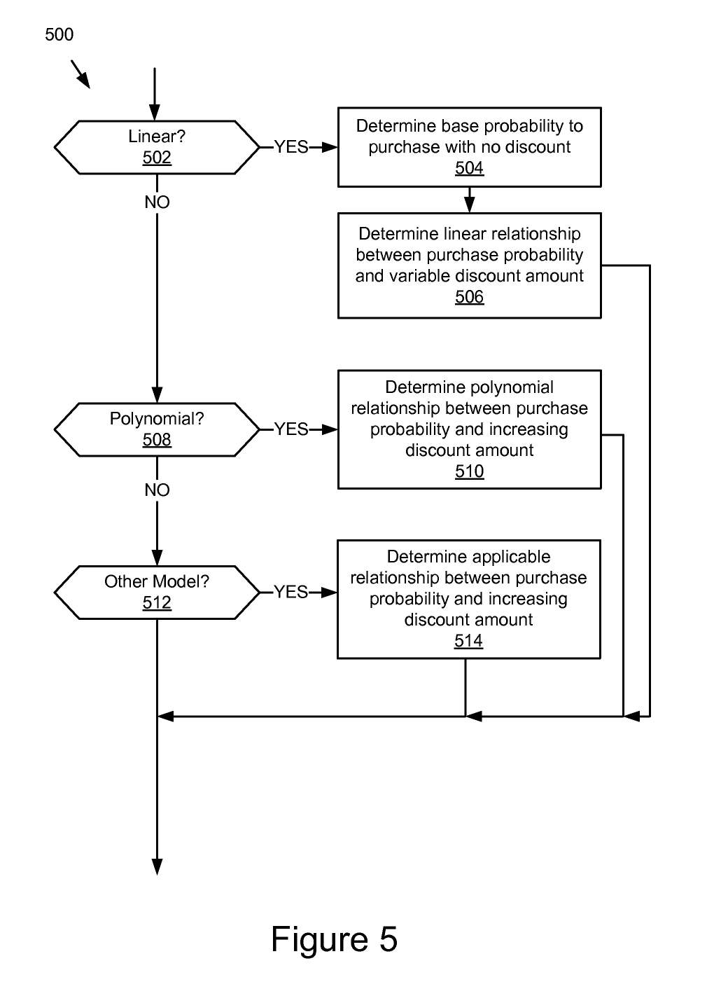

In some implementations, the probability computation module 322 and/or the learning module 326 may determine the discount pricing models and/or the discount response, as described herein with reference to at least FIG. 5.

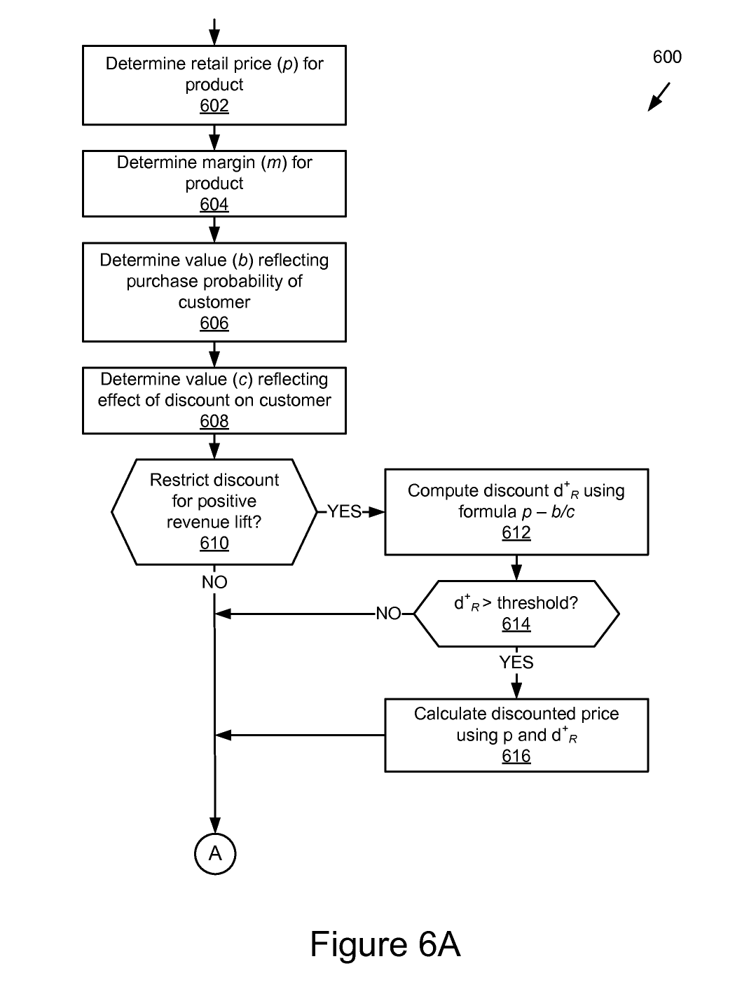

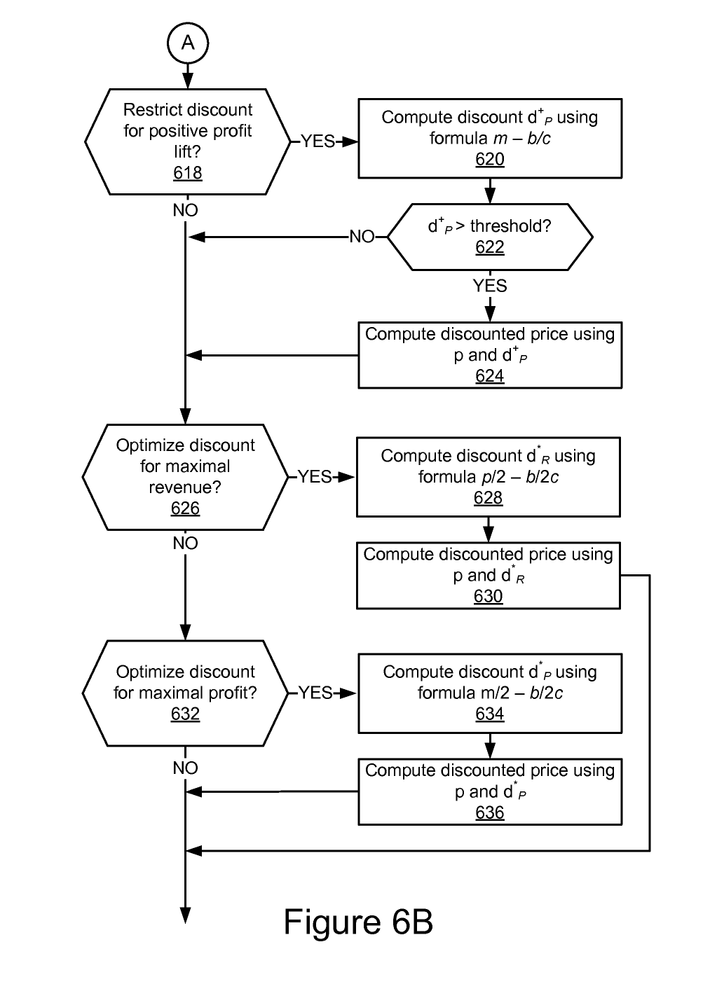

In block 406, the price computation module 324 may calculate a discounted price and/or discount-corrected margin for a product associated with a product page based on the purchase probability of the customer(s). The price computation module 324 may retrieve pricing data 246 for a product from the data storage 214 as further described at least in reference to FIG. 6A. The price computation module 324 may receive one or more purchase probabilities from the probability computation module 322 and/or from the data storage 214 as described in further detail at least in reference to FIG. 6A. The price computation module 324 may use the pricing data 246 and the purchase probability(ies) to calculate a discounted price and/or a discount-corrected margin for a particular product page view as described in further detail in reference to at least FIGS. 6A-8.

In block 408, the price computation module 324 determines whether it should predict revenue. The determination may be based on a business preference, such as a stored preference specified by a stakeholder (e.g., administrator, business executive) (e.g., using a corresponding user interface presented on a client device 106 via the client application 108). The preference may be universal or unique to a particular product, class of products, class of users, date range, etc. If the determination in block 408 is positive, then the process continues to block 410.

In block 410, the price computation module 324 may calculate the predicted revenue for a product. In some implementations, the predicted revenue may be calculated based on the number of visits by users to the product page, the purchase probability(ies), and the discounted price(s) of the product. The predicted revenue can be calculated, for example, across a plurality of users or a single users (e.g., views by a single user, views by a plurality of users, etc.).

In some implementations, the predicted revenue is calculated by multiplying the total number of page views by the purchase probability by the total discounted price of a product. For example, if there are 10,000 page views of a product page, the average purchase probability is 20%, and the discounted price is $20, then the predicted revenue for that product/product page would be $40,000 (e.g., $10,000*20*0.2=$40,000). In some implementations, the price computation module 324 may calculate the predicted revenue for a single page view. For example, if the discounted price for a product is $20 and there is a 20% chance that a particular user will purchase the product, then the predicted revenue for that page view (e.g., how much the particular page view is worth in potential revenue) is $4 (e.g., $20*0.2=$4).

If the determination in block 408 is negative, then the process 400 proceeds to block 412. The price computation module 324, in block 412, calculates the predicted profit for a product. In some implementations, the predicted profit may be calculated based on the number of visits by users to the product page, the purchase probability(ies), and the discount-corrected margin(s) for the product. The predicted revenue can be calculated, for example, across a plurality of users or a single users (e.g., views by a single user, views by a plurality of users, etc.).

In some implementations, the predicted profit is calculated by multiplying the total number of page views by the purchase probability by the discount-corrected margin for a product/product page. For example, if there are $10,000 views of a product page, the average purchase probability is 20%, and the discount-corrected margin is $10, then the predicted profit for that product/product page would be $20,000 (e.g., $10,000*10*0.2=$20,000). In some implementations, the price computation module 324 may calculate the predicted profit for a single page view. For example, the discount-corrected margin (e.g., profit) for a product is $10 and there is a 20% chance that a particular user will purchase the product, then the predicted profit (e.g., how much the particular page view is worth in potential profit) is $2 (e.g., $10*0.2=$2). In some implementations, the process 400 continues to determine optimal profits or optimal revenues as described with reference to at least FIGS. 6A-8.

FIG. 5 is a flowchart of an example process 500 for determining a discount response. In block 502, the probability computation module 322 determines whether a discount response is linear. In some implementations, the determination in block 502 is based on administrative settings for a product or class of products. In further implementations, the probability computation module 322 can dynamically determine the type of discount response to use (e.g., linear vs. polynomial) based on situational parameters (e.g., type or product, class of user, user preference, user interest, number of visits by user to product page, etc.).

If the determination in block 502 is positive, the process 500 continues to block 504 where the probability computation module 322 determines a base probability (also referred to herein as the initial purchase probability) to purchase with no discount. Once the probability computation module 322 has determined the base probability, the process 500 may continue to block 506, where the probability computation module 322 determines a linear relationship between the purchase probability and variable discount amount. In other words, the probability computation module 322 determines a discount response.

As described elsewhere herein, the linearity of a discount response can be determined based initial and final purchase probabilities at initial and final prices. In some implementations, the initial and final prices correspond to a retail price and discounted price. For example, the initial price may be the retail price and the final price may be a 100% discount (e.g., free) such that the slope of the discount response is one, as discussed elsewhere herein.

In some implementations, the initial and final prices correspond to an initial discounted price and a final discounted price. As described above, the initial and final discounted prices may be determined based on web analytics data 240, product data 242, or pricing data 246, etc. For example, an initial discounted price may be the high point in a range of market prices for a product and the final discounted price may be the low point in a range of market prices for the product. A probability to buy may be represented as a function of a variable discount. In the instance where the function is linear it can be represented by the equation F(d)=b+c*d, where F(d) is a purchase probability, b is the base probability or purchase probability at the initial price, c is a discount response, and d is the price discount.

In some implementations, revenue, as a function of discount, may be computed using the following equation R(d)=F(d)*(p−d) and, in the case of linear F(d), revenue may be represented as R(d)=(b+c*d)*(p−d), where b is the base probability or purchase probability at the initial price, c is the discount response, d is the price discount, and p is the initial price. To calculate the maximal possible discount without decreasing revenue, the inequality R(d)≧R(0) can be solved as

$$d \leq p - \frac{b}{c} .$$

The optical discount value for obtaining maximal revenue may be determined by differentiating the revenue function R(d) and setting it equal to zero, thus yielding the equation

$$d = \frac{p}{2} - \frac{b}{2 c} .$$

Similar formulae for computing the optimal discount for maximizing profit can be calculated by replacing the initial price p with the initial margin m.

In block 508, the probability computation module 322 determines whether a discount response is polynomial. In some implementations, the determination in block 508 is based on administrative settings for a product or class of products. If the determination in block 508 is affirmative, the method 500 proceeds to block 510, where the probability computation module 322 may determine a polynomial relationship between purchase probability and increasing discount amount. While the foregoing examples describe the discount response in terms of linear and polynomial, it should understood that the discount response may have other forms, such as partially linear, partially polynomial, a combination of the foregoing, etc., as discussed in reference to block 512, for example.

In some implementations, polynomialarity of the discount response is based on web analytics data 240, product data 242, user profile data 244, pricing data 246, etc. For example, the probability computation module 322 may determine that the discount response is essentially zero (e.g., a change in price discount does not substantially affect the purchase probability) outside a certain range of discounted prices, but has some shape in the range of discounted prices. In some implementations, the probability computation module 322 and/or the learning module 326 may determine the shape of a curve (e.g., F(d), the discount pricing model, or the discount response) in the range based on the data in the data storage 214. For example, the learning module may have previously determined (e.g., using linear regression, a neural network, or other suitable computer learning methods) the polynomialarity of a discount response to create a polynomial discount pricing model for a given situation. In some implementations, the probability computation module 322 may retrieve the polynomial discount pricing model from the data storage 214 based on matching attributes of the situation (e.g., of a user, the user's history, the product, etc.) to an appropriate model.

In block 512, the probability computation module 322 may determine, in some implementations, whether a discount response corresponds to a model other than those discussed above (e.g., linear, polynomial), such as a partially linear model or other suitable approximation. In some implementations, the determination in block 512 is based on administrative settings for a product or class of products. In some implementations, the determination in block 512 may be based on previous results for a particular product, class of products, user, or class of users, etc. For example, the probability computation module 322 may determine that for a particular product or class of products (or other criteria, such as web analytics data 240, product data 242, user profile data 244, etc.) another model is more accurate for a given transaction (e.g., a partially linear model). If the determination in block 512 is affirmative, the method 500 proceeds to block 514, where the probability computation module 322 may determine the applicable relationship between purchase probability and increasing discount amount.

FIGS. 6A and 6B depict flowcharts of an example process 600 for determining a discount-corrected margin specific to a user/customer for a particular product. In block 602, the price computation module 324 retrieves a price (p) for a product from the data storage 214. In some implementations, the price may be a retail price. In some implementations, it may be an initial price, as described elsewhere herein. For example, the price computation module 324 retrieves pricing data 246 including the price from the data storage 214. In block 604, the price computation module 324 determines a margin (m) for the product. In some implementations, the price computation module 324 may calculate the margin (m) based on the price and a wholesale cost of the product to a retailer. The margin may, for instance, be the difference between an initial price (e.g., a retail price) of a product and the cost of the product to the retailer. In some implementations, the price computation module 324 may retrieve and use pricing data 246 including a precomputed margin (m) from the data storage 214.

In block 606, the probability computation module 322 may determine a value (b) reflecting the purchase probability of a customer. The price computation module 324 may receive this value (b) from the probability computation module 322 or may retrieve purchase probability data 248 including this value (b) from the data storage 214, as discussed elsewhere herein. In some implementations, the value (b) may reflect the purchase probability at a retail price or an initial price as discussed elsewhere herein. In block 608, the probability computation module 322 determines the value (c) reflecting the effect of discount on a customer (e.g., the purchase probability for the customer). In some implementations, the value (c) may be the discount response, as discussed elsewhere herein. The probability computation module 322 may store the value (c) as purchase probability data 248 for retrieval by the price computation module 324, or may provide the value (c) directly to the price computation module 324 for use thereby.

In block 610, the price computation module 324 determines whether to restrict the discount for positive revenue lift (e.g., the maximal price discount while still increasing predicted revenue). If the determination in block 610 is affirmative, in block 612, the price computation module 324 computes the maximal discount (4) for positive revenue lift using the formula d_{R}⁺=p−b/c. In block 614, the price computation module 324 determines whether the maximal discount (d_{R}⁺) for positive revenue lift is greater than a threshold. The threshold may be set by a stakeholder, for example, based on a business earning objective, as discussed elsewhere herein. In some implementations, the threshold may correspond to the maximal discount before predicted profit decreases. For example, the price computation module 322 may determine that no discount should be offered for a particular product in the situation where the price discount would result in the predicted profit being lower than the predicted profit for the product with no discount.

In block 616, the price computation module 324 calculates a discounted price using the price (p) and the maximal discount (d_{R}⁺) for positive revenue lift. For example, if the price (p) for the product is $20, the initial purchase probability is 40%, and the discount response (c) is linear with a slope of 1

$$( e . g . , \frac{100 \%}{\$20} ) ,$$

then the maximal discount (d_{R}⁺) for positive revenue lift is $12, and the lowest allowed discounted price for positive revenue lift is greater than or equal to $8.

In another example, the discount response (c) may be equal to 1−b (e.g., the discount response (c) is linear from zero discount to a 100% discount taking into consideration the initial probability b). For example, if the price (p) for the product is $20, the initial purchase probability is 20%, and the discount response is linear with a slope of 0.8 (1−0.2), then the maximal discount (d_{R}⁺) for positive revenue lift is $15, and the lowest allowed discounted price for positive revenue lift is greater than or equal to $5. Numerous further examples are also possible and contemplated.

In block 618, the price computation module 324 determines whether to restrict the discount for positive profit lift (e.g., the maximal price discount while still increasing predicted profit). If the determination in block 618 is affirmative, in block 620, the price computation module 324 computes the maximal discount (dₚ⁺) for positive profit lift using the formula dₚ⁺=m−b/c. In block 622, the price computation module 324 determines whether the maximal discount (dₚ⁺) for positive profit lift is greater than a threshold. The threshold may be set by a stakeholder based on a business earning objective (e.g., profit vs. revenue). In some implementations, the threshold corresponds to the maximal discount before predicted revenue decreases. For example, the price computation module 322 will determine that no price discount should be offered for a particular product in the situation where the discount would result in the predicted revenue being lower than the predicted revenue for the product with no discount.

In block 624, the price computation module 324 calculates a discounted price using the price (p) and the maximal discount (dₚ⁺) for positive profit lift. For example, if the price (p) of the product is $20 and the margin (m) is $10, the initial purchase probability is 40%, and the discount response (c) is linear with a slope of 1

$$( e . g . , \frac{100 \%}{\$20} ) ,$$

then the maximal discount (dₚ⁺) for positive profit lift is $2, and the lowest allowed discounted price for positive profit lift is greater than $18. In a parallel example, where the initial purchase probability is 20%, the maximal discount for positive profit lift would be $4 and the lowest allowed discounted price for positive profit lift is greater than or equal to $16.

In block 626, the price computation module 324 determines whether to optimize the discount for maximal revenue. If the determination in block 626 is affirmative, in block 628, the price computation module 324 computes the optimal discount (d*_{R}) for maximal revenue using the formula

$${d}_{R}^{*} = \frac{p}{2} - \frac{b}{2 c} .$$

In block 630, the price computation module 324 calculates a discount price using the price (p) and the optimal discount (d*_{R}) for maximal revenue. For example, if the price (p) for the product is $20, the initial purchase probability is 40%, and the discount response (c) is linear with a slope of 1 (e.g.,

$$\frac{100 \%}{\$20} ) ,$$

then the optimal discount (d*_{R}) for maximal revenue is $6 and the revenue-optimal discounted price would be $14.

In block 632, the price computation module 324 determines whether to optimize discount for maximal profit. If the determination in block 632 is affirmative, in block 634, the price computation module 324 computes the optimal discount (d*_{R}) for maximal profit using the formula

$${d}_{P}^{*} = \frac{m}{2} - \frac{b}{2 c} .$$

In block 636, the price computation module 324 calculates a discount price using the price (p) and the optimal discount (d*ₚ) for maximal profit. For example, if the price (p) for the product is $20 and the margin is $10, the initial purchase probability is 40%, and the discount response (c) is linear with a slope of 1 (e.g.,

$$\frac{100 \%}{\$20} ) ,$$

then the optimal discount (d*ₚ) for maximal profit is $1, and the profit-optimal discounted price is $19. In a parallel example, where the initial purchase probability is 20%, the optimal discount for maximal profit would be $3 and the profit-optimal discounted price would be $17.

While the operations in FIGS. 6A and 6B are described in terms of a specific linear discount response, it should be understood that other discount responses are possible, compatible, and contemplated. For example, the discount response could be non-linear, such that the purchase probability as a function of discount is non-linear (e.g., polynomial, partially linear, discontinuous, etc.). As a further example, the price computation module 324 may optimize profit (or maximize revenue, optimize revenue, maximize revenue, etc.) using any curve or series of purchase probabilities.

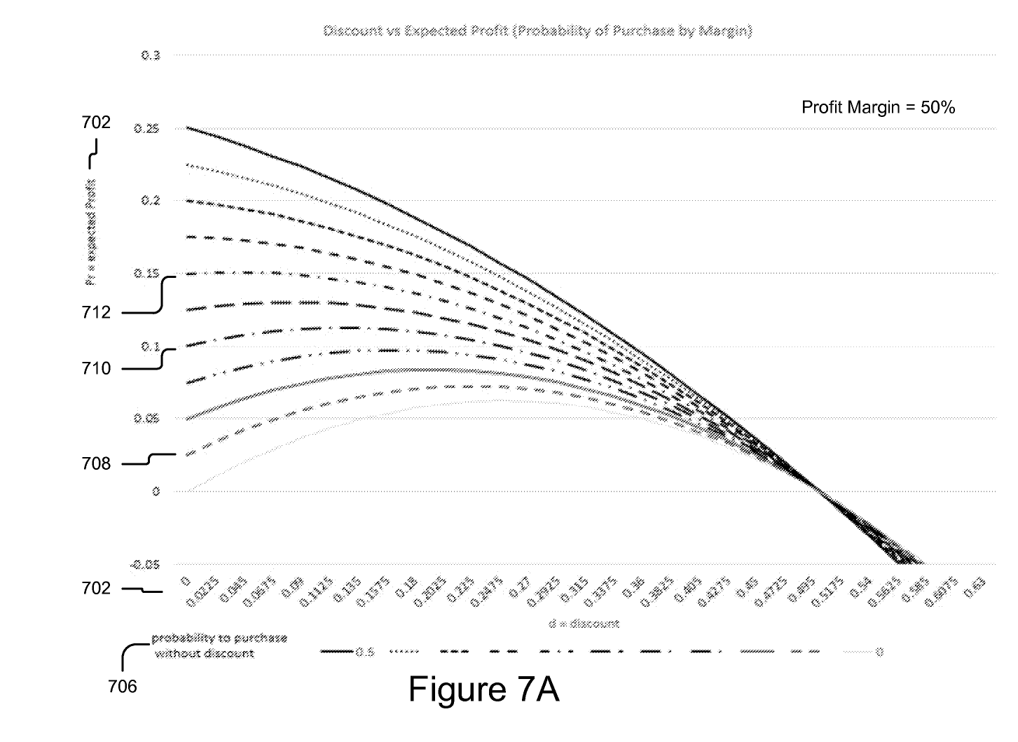

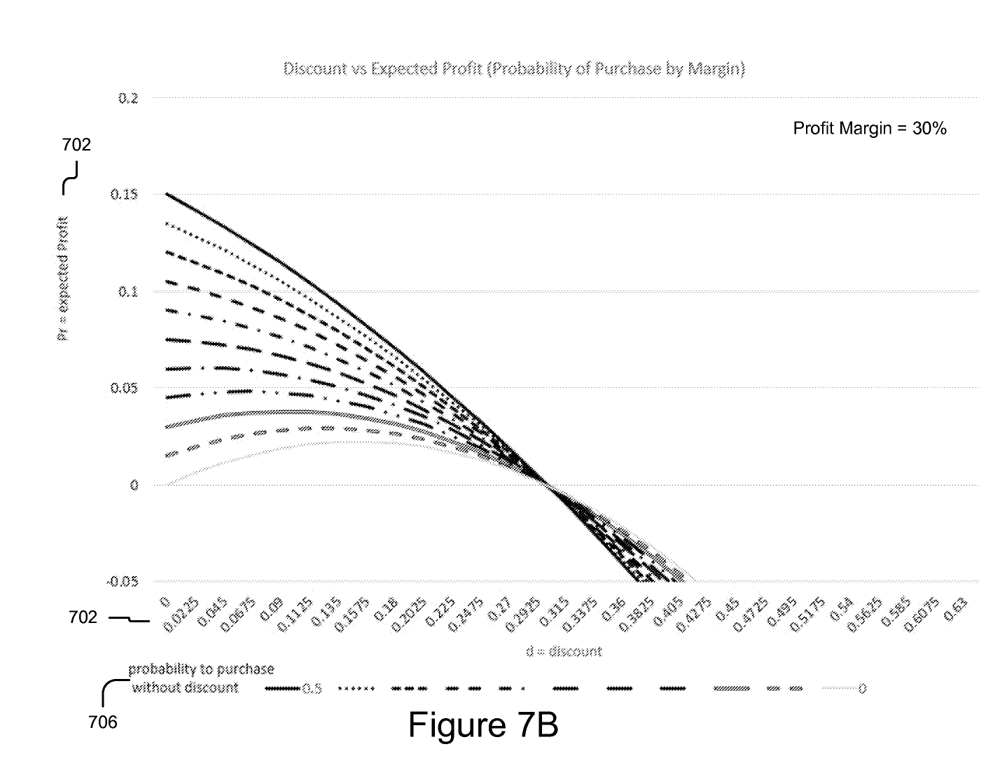

FIGS. 7A and 7B are example graphs of expected profits as a function price discounts. Each of the FIGS. 7A and 7B show lines corresponding to various initial purchase probabilities. The “y” axis of the graphs corresponds to the expected profit 702 (e.g., the margin multiplied by the purchase probability) at each initial purchase probability over a range 704 of discount percentages (e.g., the “x” axis). Each graph shows a legend 706 showing the initial purchase probability at several different values. Each graph uses the example implementation and corresponding equations described in reference to FIGS. 6A and 6B. It can be seen that the higher the initial purchase probability the less likely a user/customer will be to receive a discount according to either optimizing the profit for maximal profit or maximizing the profit for positive profit lift.

FIG. 7A shows the effect of a margin of 50% (e.g., 0.5) on expected profit curves and corresponding optimal and maximal discounts. In this figure, the example discount response (c) is set as 1−b, although other variations are possible, as discussed below for example. If a user has an initial purchase probability of 10% as indicated by curve 708, the price calculation engine 126 may provide a much larger discount to the user than if the initial purchase probability was 20% as indicated by curve 710. The graph in FIG. 7A also shows that for initial purchase probabilities higher than approximately 30% (as shown by line 712), the likelihood of receiving any discount is relatively low or non-existent.

In further examples, if the initial purchase probability (b) is 0%, then the optimal discount (for maximal profit) would be 25%

$$( {d}_{P}^{*} = \frac{m}{2} - \frac{b}{2 c} = \frac{0.5}{2} - \frac{0}{2} = 0.25 ) .$$

If the initial purchase probability (b) is 10%, then the optimal discount (for maximal profit) would be 19.5%

$$( {d}_{P}^{*} = \frac{m}{2} - \frac{b}{2 c} = \frac{0.5}{2} - \frac{0.1}{2 ( 1 - 0.1 )} = 0.195 ) .$$

If the initial purchase probability (b) is 20% (e.g., b=0.2%), then the optimal discount (for maximal profit) would be 12.5%

$$( {d}_{P}^{*} = \frac{m}{2} - \frac{b}{2 c} = \frac{0.5}{2} - \frac{0.2}{2 ( 1 - 0.2 )} = 0.125 ) .$$

Thus, those users with lower initial purchase probabilities are more likely to be given larger discounts and provide higher expected profits.

FIG. 7B shows the effect of a margin of 30% (e.g., 0.3) on expected profit curves and corresponding optimal and maximal discounts, assuming an example discount response (c) of 1−b. The discounts provided are, as shown, be much smaller for a smaller margin. The graph in 7B also shows that the highest initial purchase probability at which a discount should be offered is lower for the margin of 30% of FIG. 7B than for 50% of FIG. 7A. For example, in a situation with a given discount response and a profit margin of 40%, the highest initial purchase probability for which a user would receive a discount may be approximately 26%. In a parallel example with the same given discount response and a profit margin of 60%, the highest initial purchase probability for which a user would receive a discount may be approximately 36%.

FIG. 8 is a flowchart of an example process 800 for optimizing a price discount for a user/customer for a particular product and for learning from a previously computed optimal price discount. In block 802, the web server 128 receives a product page request from a client computing device 106 associated with a user/customer 112. The web server 128 may receive the request and generate a response in conjunction with the e-commerce engine 124 and/or the price calculation engine 126. In response to the receiving the request, the process 800 may proceed to block 804.

In block 804, the price computation module 324 calculates an optimized price (e.g., as described elsewhere herein) for the product by balancing customer probability to purchase and a business earning objective. Non-limiting examples of the business earning objective are maximizing revenue or profit for maximal revenue or profit lift, optimizing revenue or profit for maximal revenue or profit, or some combination thereof. For example, the business earning objective may be that the profit should be optimized for maximal profit within a certain range of revenues. For example, the business earning objective may be to optimize revenue within a certain range of profit. In a further example, the business earning objective to optimize revenue without decreasing the profit (e.g., the revenue is maximized without cannibalizing profit).

In block 806, the web server 128 may generate data for a product page including the optimal product price and option for purchasing the product. In some implementations, the product page may indicate both the retail price for the product as well as an indication of the discounted price and/or duration thereof. For example, the product page may display a retail price, a discounted price, and that the discounted price is available for the current browsing session only. In another example, the product page (in cooperation with the client application 108 and/or the server 122 components) may make the discounted price available for a certain time period.

In block 808, the server 122 may send the data for the product page to the client device 106 for display to the user/customer. The client application 108, for example, may receive the data for the product page and present/display the product page on the client/computing device 106 to the user.

In block 810, the learning module 326 tracks the effect of the price discount, as described elsewhere herein. In block 812, the learning module 326 adapts algorithms(s) for discounting price based on the effect of the discount, as discussed elsewhere herein. The algorithm(s) may include the discount pricing models 250, the purchase probability(ies), discount response(s), etc.

FIG. 9 is a flowchart of an example process 900 for reporting the effectiveness of the price calculation engine 126. In block 902, the web server 128 receives a request from a computing device (e.g., a client device 106) associated with a stakeholder. In block 904, the reporting module 330 generates the report summarizing the effect of discounts on conversion rates and stores the report in the report data 254. In some implementations, the reporting module 254 generates reports tracking the performance of the price calculation engine 126, such as the accuracy of the discounts, and or the actual effect of the discounts on profits and/or revenue vs. a predicted effect, etc. Performance of the price calculation engine 126 included in the reports may be determined based on the data generated by the various components of the price calculation engine 126 and stored in the data storage 214, as discussed elsewhere herein. For example, the reporting module 330 may track the effect of optimized discounts on conversion rates (of potential sales to completed sales).

In block 906, the reporting module 330 via the web server 128 provides reports for presentation to the stakeholder (e.g., the reporting module 330 may send the report to a computing device 106 associated with the stakeholder for display to the stakeholder).

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer-implemented method comprising:
storing, in a non-transitory computer-usable storage medium coupled to a server, profile data specific to a customer;
storing, in the non-transitory computer-usable storage medium, product information specific to one or more of the product or a class of products to which the product belongs, the product information including at least a profit margin at a retail price;
receiving, using the server, a request for the product page associated with the product from a client device of the customer;
calculating, using the server, a purchase probability of the customer for the product as a function of a price discount based on one or more of the profile data and the product information;
determining, using the server, a discount-corrected margin for the product based on the purchase probability of the customer by subtracting the price discount from the profit margin;
calculating, using the server, a predicted profit or a predicted revenue for the product based on the purchase probability and the discount-corrected margin of the product;
calculating, using the server, an optimal price discount for the product based on the predicted profit or the predicted revenue;
generating, using one or more of the server and the client device, the product page including the optimal price specific to the customer for the product and an option to purchase the product at the optimal price; and
presenting the product page on the client device of the customer for display to the customer.

2. The computer-implemented method of claim 1, comprising:
tracking, using the server, an effect of the price discount; and
adapting, using the server, one or more algorithms for calculating a price discount for the product based on the effect responsive to a future request for the product page by a client device of a future customer.

3. A computer-implemented method comprising:
determining, using one or more computing devices, a number of visits to a product page of a particular product by one or more customers, the product page being accessible by one or more client devices of the one or more customers;
calculating, using the one or more computing devices, a purchase probability of a customer to purchase the particular product associated with the product page as a function of a price discount;
determining, using the one or more computing devices, a discount-corrected margin specific to the customer for the particular product based on the purchase probability of the customer;
calculating, using the one or more computing devices, a predicted profit or a predicted revenue for the particular product resulting from the number of visits to the product page and based on the purchase probability and the discount-corrected margin of the particular product.

4. The computer-implemented method of claim 3, further comprising:
receiving, using the one or more computing devices, a product page request from the client device of a customer;
calculating, using the one or more computing devices, an optimal price for the particular product by balancing the purchase probability for the customer and a business earning objective to optimize profit or revenue;
generating, using the one or more computing devices, the product page including the optimal price specific to the customer for the particular product and an option to purchase the particular product at the optimal price; and
presenting, using the one or more computing devices, the product page on the client device of the customer for display to the customer.

5. The computer-implemented method of claim 4, further comprising:
tracking, using the one or more computing devices, an effect of the price discount; and
adapting, using the one or more computing devices, one or more algorithms for discounting the price for the particular product based on the effect of the price discount, responsive to a future request for the product page by a client device of a future customer.

6. The computer-implemented method of claim 5, further comprising:
receiving, using the one or more computing devices, a report request from a client device of a stakeholder;
generating, using the one or more computing devices, a report summarizing the effect of the price discount on conversion rates; and
providing, using the one or more computing devices, the report for presentation on the client device of the stakeholder for display to the stakeholder.

7. The computer-implemented method of claim 3, wherein determining the discount-corrected margin further comprises determining a discount response.

8. The computer-implemented method of claim 7, wherein determining the discount response further comprises:
determining, using the one or more computing devices, the discount response to be linear or polynomial;
if the discount response is linear, then determining a base probability to purchase the particular product with no discount, and determining the linearity between the purchase probability and a variable price discount amount; and
if the discount response is polynomial, then determining the polynomialarity between the purchase probability and the variable price discount amount.

9. The computer-implemented method of claim 3, wherein:
determining the discount-corrected margin further comprises:
determining, using the one or more computing devices, a retail price (p) for the particular product, and
determining, using the one or more computing devices, a margin (m) for the particular product;
calculating the purchase probability of the customer to purchase the particular product further comprises:
determining, using the one or more computing devices, a value (b) reflecting the purchase probability of the customer; and
determining, using the one or more computing devices, a value (c) reflecting a discount response, wherein the discount response reflects an effect of a change in the price discount on the purchase probability of the customer; and
calculating the predicted profit or the predicted revenue for the particular product further comprises:
determining, using the one or more computing devices, whether to maximize the price discount for a positive revenue lift;
computing, using the one or more computing devices, a revenue-maximum discount (d_{R}) using the formula
$${d}_{R} = p - \frac{b}{c} ;$$
determining, using the one or more computing devices, whether the revenue-maximum discount (d_{R}) is greater than a threshold; and
calculating, using the one or more computing devices, a discounted price using the retail price (p) and the maximum price discount (d_{R}).

10. The computer-implemented method of claim 3, wherein:
determining the discount-corrected margin further comprises:
determining, using the one or more computing devices, a retail price (p) for the particular product; and
determining, using the one or more computing devices, a margin (m) for the particular product;
calculating the purchase probability of the customer to purchase the particular product further comprises:
determining, using the one or more computing devices, a value (b) reflecting the purchase probability of the customer;
determining, using the one or more computing devices, a value (c) reflecting a discount response, wherein the discount response reflects an effect of a change in the price discount on the purchase probability of the customer; and
calculating the predicted profit or the predicted revenue for the particular product further comprises:
determining, using the one or more computing devices, whether to maximize the price discount for a positive profit lift;
computing, using the one or more computing devices, a profit-maximum discount (dₚ) using the formula
$${d}_{P} = m - \frac{b}{c} ;$$
determining, using the one or more computing devices, whether the profit-maximum discount (dₚ) is greater than a threshold; and
calculating, using the one or more computing devices, a discounted price using the retail price (p) and the profit-maximum price discount (d_{R}).

11. The computer-implemented method of claim 3, wherein:
determining the discount-corrected margin further comprises:
determining, using the one or more computing devices, a retail price (p) for the particular product;
determining, using the one or more computing devices, a margin (m) for the particular product;
calculating the purchase probability of the customer to purchase the particular product further comprises:
determining, using the one or more computing devices, a value (b) reflecting the purchase probability of the customer;
determining, using the one or more computing devices, a value (c) reflecting a discount response, wherein the discount response reflects an effect of a change in the price discount on the purchase probability of the customer; and
calculating the predicted profit or the predicted revenue for the particular product further comprises:
determining, using the one or more computing devices, whether to optimize the price discount for maximal revenue;
computing, using the one or more computing devices, a revenue-optimal discount (D_{R}) using the formula
$${D}_{R} = \frac{p}{2} - \frac{b}{2 c} ;$$
and
computing, using the one or more computing devices, a discounted price using the retail price (p) and the revenue-optimal discount (D_{R}).

12. The computer-implemented method of claim 3, wherein:
determining the discount-corrected margin further comprises:
determining, using the one or more computing devices, a retail price (p) for the particular product;
determining, using the one or more computing devices, a margin (m) for the particular product;
calculating the purchase probability of the customer to purchase the particular product further comprises:
determining, using the one or more computing devices, a value (b) reflecting the purchase probability of the customer;
determining, using the one or more computing devices, a value (c) reflecting a discount response, wherein the discount response reflects an effect of a change in the price discount on the purchase probability of the customer; and
calculating the predicted profit or the predicted revenue for the particular product further comprises:
determining, using the one or more computing devices, whether to optimize the price discount for maximal profit;
computing, using the one or more computing devices, a profit-optimal discount (Dₚ) using the formula
$${D}_{P} = \frac{m}{2} - \frac{b}{2 c} ;$$
and
computing, using the one or more computing devices, a discounted price using the retail price (p) and the profit-optimal discount (Dₚ).

13. A computing system comprising:
one or more processors;
one or more memories storing instructions that, when executed by the one or more processors, cause the computing system to perform acts including:
determining a number of visits to a product page of a particular product by one or more customers, the product page being accessible by one or more client devices of the one or more customers;
calculating a purchase probability of a customer to purchase the particular product associated with the product page as a function of a price discount;
determining a discount-corrected margin specific to the customer for the particular product based on the purchase probability of the customer; and
calculating a predicted profit or a predicted revenue for the particular product resulting from the number of visits to the product page and based on the purchase probability and the discount-corrected margin of the particular product.

14. The computing system of claim 13, wherein the instructions, when executed by the one or more processors, further cause the computing system to perform acts including:
receiving a product page request from the client device of a customer;
calculating an optimal price for the particular product by balancing the purchase probability for the customer and a business earning objective to optimize profit or revenue;
generating the product page including the optimal price specific to the customer for the particular product and an option to purchase the particular product at the optimal price; and
presenting the product page on the client device of the customer for display to the customer.

15. The computing system of claim 14, wherein the instructions, when executed by the one or more processors, further cause the computing system to perform acts including:
tracking an effect of the price discount; and
adapting one or more algorithms for discounting the price for the particular product based on the effect of the price discount, responsive to a future request for the product page by a client device of a future customer.

16. The computing system of claim 15, wherein the instructions, when executed by the one or more processors, further cause the computing system to perform acts including:
receiving a report request from a client device of a stakeholder;
generating a report summarizing the effect of the price discount on conversion rates; and
providing the report for presentation on the client device of the stakeholder for display to the stakeholder.

17. The computing system of claim 13, wherein determining the discount-corrected margin further comprises determining a discount response.

18. The computing system of claim 17, wherein determining the discount response further comprises:
determining the discount response to be linear or polynomial;
if the discount response is linear, then determining a base probability to purchase the particular product with no discount, and determining the linearity between the purchase probability and a variable price discount amount; and
if the discount response is polynomial, then determining the polynomialarity between the purchase probability and the variable price discount amount.

19. The computing system of claim 13, wherein:
determining the discount-corrected margin further comprises:
determining a retail price (p) for the particular product, and
determining a margin (m) for the particular product;
calculating the purchase probability of the customer to purchase the particular product further comprises:
determining a value (b) reflecting the purchase probability of the customer; and
determining a value (c) reflecting a discount response, wherein the discount response reflects an effect of a change in the price discount on the purchase probability of the customer; and
calculating the predicted profit or the predicted revenue for the particular product further comprises:
determining whether to maximize the price discount for a positive revenue lift;
computing a revenue-maximum discount (d_{R}) using the formula
$${d}_{R} = p - \frac{b}{c} ;$$
determining whether the revenue-maximum discount (d_{R}) is greater than a threshold; and
calculating, using the one or more computing devices, a discounted price using the retail price (p) and the maximum price discount (d_{R}).

20. The computing system of claim 13, wherein:
determining the discount-corrected margin further comprises:
determining a retail price (p) for the particular product; and
determining a margin (m) for the particular product;
calculating the purchase probability of the customer to purchase the particular product further comprises:
determining a value (b) reflecting the purchase probability of the customer;
determining a value (c) reflecting a discount response, wherein the discount response reflects an effect of a change in the price discount on the purchase probability of the customer; and
calculating the predicted profit or the predicted revenue for the particular product further comprises:
determining whether to maximize the price discount for a positive profit lift;
computing a profit-maximum discount (dₚ) using the formula
$${d}_{P} = m - \frac{b}{c} ;$$
determining whether the profit-maximum discount (dₚ) is greater than a threshold; and
calculating a discounted price using the retail price (p) and the profit-maximum price discount (d_{R}).

21. The computing system of claim 13, wherein:
determining the discount-corrected margin further comprises:
determining a retail price (p) for the particular product;
determining a margin (m) for the particular product;
calculating the purchase probability of the customer to purchase the particular product further comprises:
determining a value (b) reflecting the purchase probability of the customer;
determining a value (c) reflecting a discount response, wherein the discount response reflects an effect of a change in the price discount on the purchase probability of the customer; and
calculating the predicted profit or the predicted revenue for the particular product further comprises:
determining whether to optimize the price discount for maximal revenue;
computing a revenue-optimal discount (D_{R}) using the formula
$${D}_{R} = \frac{p}{2} - \frac{b}{2 c} ;$$
and
computing a discounted price using the retail price (p) and the revenue-optimal discount (D_{R}).

22. The computing system of claim 13, wherein:
determining the discount-corrected margin further comprises:
determining a retail price (p) for the particular product;
determining a margin (m) for the particular product;
calculating the purchase probability of the customer to purchase the particular product further comprises:
determining a value (b) reflecting the purchase probability of the customer;
determining a value (c) reflecting a discount response, wherein the discount response reflects an effect of a change in the price discount on the purchase probability of the customer; and
calculating the predicted profit or the predicted revenue for the particular product further comprises:
determining whether to optimize the price discount for maximal profit;
computing a profit-optimal discount (Dₚ) using the formula
$${D}_{P} = \frac{m}{2} - \frac{b}{2 c} ;$$
and
computing discounted price using the retail price (p) and the profit-optimal discount (Dₚ).
